(19) United States
(12) Patent Application Publication
(10) Pub. No.: US 2026/0017250 A1
(43) Pub. Date: Jan. 15, 2026

(54) DATA TABLE PROCESSING METHOD AND APPARATUS, COMPUTER DEVICE, AND READABLE STORAGE MEDIUM

(71) Applicant: TENCENT TECHNOLOGY (SHENZHEN) COMPANY LIMITED, SHENZHEN (CN)

(72) Inventors: Sheng YE, SHENZHEN (CN); Anqun PAN, SHENZHEN (CN); Hailin LEI, SHENZHEN (CN); Lixiong ZHENG, SHENZHEN (CN)

(73) Assignee: TENCENT TECHNOLOGY (SHENZHEN) COMPANY LIMITED, SHENZHEN (CN)

(21) Appl. No.: 19/338,373

(22) Filed: Sep. 24, 2025

Related U.S. Application Data
(63) Continuation of application No. PCT/CN2024/114125, filed on Aug. 23, 2024.

(30) Foreign Application Priority Data
Oct. 24, 2023 (CN) 202311381633.7

(51) Int. Cl. G06F 16/23; G06F 16/22; G06F 16/2455; G06F 16/27

(52) U.S. Cl. CPC G06F 16/2379; G06F 16/2282; G06F 16/24565; G06F 16/275

(57) ABSTRACT

The present disclosure provides methods, devices, apparatus, and storage medium for data migration. One method includes obtaining source table structure information of a source data table, changing the source table structure information, and creating a target data table based on changed table structure information; determining a plurality of source primary keys in the source data table; successively migrating the source primary keys and the source data in the source data table to the target data table, each migration starting after previous migration succeeds; generating a migration progress record of each migration; determining a migration progress record at migration interruption when the migration interruption occurs, and determining a source primary key at the migration interruption in the source data table; and continuing to successively migrate, starting from the source primary key at the migration interruption in the source data table, an unmigrated source primary key and unmigrated source data.

### RELATED APPLICATION

This application is a continuation application of PCT Patent Application No. PCT/CN2024/114125, filed on Aug. 23, 2024, which claims priority to Chinese Patent Application No. 202311381633.7, filed on Oct. 24, 2023, both of which are incorporated herein by reference in their entireties.

### FIELD OF THE TECHNOLOGY

The present disclosure relates to the field of computer technologies, and in particular, to a data table processing method and apparatus, a computer device, a computer-readable storage medium, and a computer program product.

### BACKGROUND OF THE DISCLOSURE

Table structure change is a necessary stage in an operation and maintenance process of a database. However, for a table having a super large data volume, performing table structure change is a time-consuming operation. It usually spends several hours or even several days to perform the table structure change once. In an execution process of the table structure change, the execution may fail due to factors such as a software defect, a hardware fault, or human interference.

According to a processing logic of a current database, once the execution fails, all data will be rolled back, and a database system is restored to a state in which the table structure change has not been performed yet. If a user hopes to continue to complete the table structure change, the table structure change needs to be performed again. This means that migrated data is invalid. Consequently, table structure change efficiency is low.

The present disclosure describes embodiments for performing data migration from a source data table to a target data table, addressing at least one problem of low data migration efficiency caused by performing data migration from the beginning in case of a table structure change failure in a conventional solution, and effectively improving the data migration efficiency, as to avoid that some data that is successfully migrated needs to be migrated again, which helps improve accuracy of data migration and a migration speed. Thus, various embodiments in the present disclosure improve the technical field of data table/database management.

### SUMMARY

According to various embodiments of the present disclosure, a data table processing method and apparatus, a computer device, a computer-readable storage medium, and a computer program product are provided.

The present disclosure describes a method for data migration from a source data table to a target data table. The method is performed by a device comprising a memory storing instructions and a processor in communication with the memory. The method may include obtaining source table structure information of a source data table, changing the source table structure information, and creating a target data table based on changed table structure information; determining, by the device, a plurality of source primary keys in the source data table, each source primary key being configured for identifying a piece of source data in the source data table; successively migrating, by the device, the source primary keys and the source data in the source data table to the target data table, by migrating at least one source primary key and the source data identified by the at least one source primary key for each migration, and each migration starting after previous migration succeeds; generating, by the device, a migration progress record of each migration; determining, by the device, a migration progress record at migration interruption when the migration interruption occurs, and determining a source primary key at the migration interruption in the source data table based on the migration progress record at the migration interruption; and continuing to successively migrate, by the device starting from the source primary key at the migration interruption in the source data table, an unmigrated source primary key and unmigrated source data in the source data table to the target data table.

The present disclosure describes an apparatus for data migration from a source data table to a target data table. The apparatus includes a memory storing instructions; and a processor in communication with the memory. When the processor executes the instructions, the processor is configured to cause the apparatus to perform: obtaining source table structure information of a source data table, changing the source table structure information, and creating a target data table based on changed table structure information, determining a plurality of source primary keys in the source data table, each source primary key being configured for identifying a piece of source data in the source data table, successively migrating the source primary keys and the source data in the source data table to the target data table, by migrating at least one source primary key and the source data identified by the at least one source primary key for each migration, and each migration starting after previous migration succeeds, generating a migration progress record of each migration, determining a migration progress record at migration interruption when the migration interruption occurs, and determining a source primary key at the migration interruption in the source data table based on the migration progress record at the migration interruption, and continuing to successively migrate, starting from the source primary key at the migration interruption in the source data table, an unmigrated source primary key and unmigrated source data in the source data table to the target data table.

The present disclosure describes a non-transitory computer-readable storage medium, storing computer-readable instructions. The computer-readable instructions, when executed by a processor, are configured to cause the processor to perform: obtaining source table structure information of a source data table, changing the source table structure information, and creating a target data table based on changed table structure information, determining a plurality of source primary keys in the source data table, each source primary key being configured for identifying a piece of source data in the source data table, successively migrating the source primary keys and the source data in the source data table to the target data table, by migrating at least one source primary key and the source data identified by the at least one source primary key for each migration, and each migration starting after previous migration succeeds, generating a migration progress record of each migration, determining a migration progress record at migration interruption when the migration interruption occurs, and determining a source primary key at the migration interruption in the source data table based on the migration progress record at the migration interruption, and continuing to successively migrate, starting from the source primary key at the migration interruption in the source data table, an unmigrated source primary key and unmigrated source data in the source data table to the target data table.

In another aspect, the present disclosure provides a data table processing method. The method includes:
obtaining source table structure information of a source data table, changing the source table structure information, and creating a target data table based on changed table structure information;
determining a plurality of source primary key values in the source data table, each source primary key value being configured for identifying a piece of source data in the source data table;
successively migrating the source primary key values and the source data in the source data table to the target data table, at least one source primary key value and the source data identified by the at least one source primary key value being migrated each time, and each migration starting after previous migration succeeds;
generating a migration progress record for each source primary key value of each migration;
determining a migration progress record at migration interruption when the migration interruption occurs, and determining a source primary key value at the migration interruption in the source data table based on the migration progress record at the migration interruption; and
continuing to successively migrate, starting from the source primary key value at the migration interruption in the source data table, an unmigrated source primary key value and unmigrated source data in the source data table to the target data table.

In another aspect, the present disclosure provides a data table processing apparatus. The apparatus includes:
a change module, configured to: obtain source table structure information of a source data table, change the source table structure information, and create a target data table of a target table structure based on changed table structure information;
a first determining module, configured to determine a plurality of source primary key values in the source data table, each source primary key value being configured for identifying a piece of source data in the source data table;
a first migration module, configured to successively migrate the source primary key values and the source data in the source data table to the target data table, at least one source primary key value and the source data identified by the at least one source primary key value being migrated each time, and each migration starting after previous migration succeeds;
a generation module, configured to generate a migration progress record for a source primary key value of each migration;
a second determining module, configured to: determine a migration progress record at migration interruption when the migration interruption occurs, and determine a source primary key value at the migration interruption in the source data table based on the migration progress record at the migration interruption; and
a second migration module, configured to: continue to successively migrate, starting from the source primary key value at the migration interruption in the source data table, an unmigrated source primary key value and unmigrated source data in the source data table to the target data table.

In another aspect, the present disclosure further provides a computer device. The computer device includes a memory and a processor, the memory having a computer program stored therein, and the processor, when executing the computer program, performing the operations of the method embodiments of the present disclosure.

In another aspect, the present disclosure further provides a computer-readable storage medium. The computer-readable storage medium has a computer program stored therein, the computer program, when executed by a processor, performing the operations of the method embodiments of the present disclosure.

In another aspect, the present disclosure further provides a computer program product. The computer program product includes a computer program, the computer program, when executed by a processor, performing the operations of the method embodiments of the present disclosure.

The details of one or more embodiments of the present disclosure are presented in the accompanying drawings and description below. Other features and advantages of the present disclosure will become apparent from the specification, accompanying drawings, and claims.

### BRIEF DESCRIPTION OF THE DRAWINGS

To describe the technical solutions in the embodiments of the present disclosure or the traditional art more clearly, the following briefly describes the accompanying drawings required for describing the embodiments or the traditional art. Apparently, the accompanying drawings in the following descriptions show merely the embodiments of the present disclosure. A person of ordinary skill in the art may still derive other drawings from the disclosed accompanying drawings without creative efforts.

FIG. 1 is a diagram of an application environment of a data table processing method in an embodiment.

FIG. 2 is a schematic flowchart of a data table processing method according to an embodiment.

FIG. 3 is a schematic diagram of source primary key values and source data in a source data table according to an embodiment.

FIG. 4 is a schematic diagram of a target data table according to an embodiment.

FIG. 5 is a schematic diagram of updating a migration progress record according to an embodiment.

FIG. 6 is a schematic diagram of a constructed progress data table according to an embodiment.

FIG. 7 is a schematic diagram of adding a migration progress record to a position of a source primary key value in a source data table according to an embodiment.

FIG. 8 is a schematic diagram of using a migration progress record as index value data corresponding to index key data.

FIG. 9 is a schematic diagram of adding a migration progress record into index key data to which source data belongs.

FIG. 10 is a schematic diagram of synchronizing a processing operation of a data processing request in a source data table to a target data table based on an association relationship.

FIG. 11 is a structural block diagram of a data table processing apparatus according to an embodiment.

FIG. 12 is a diagram of an internal structure of a computer device according to an embodiment.

### DESCRIPTION OF EMBODIMENTS

The technical solutions in embodiments of the present disclosure are clearly and completely described in the following with reference to the accompanying drawings in the embodiments of the present disclosure. Apparently, the described embodiments are merely some rather than all of the embodiments of the present disclosure. All other embodiments obtained by a person of ordinary skill in the art based on the embodiments of the present disclosure without making creative efforts shall fall within the protection scope of the present disclosure.

A data table in a data table processing method provided in an embodiment of the present disclosure may be a data table in a big data warehouse. Big data refers to a set of data that cannot be captured, managed, and processed by using conventional software tools within a specific time range. Big data is a massive, high-growth, and diverse information asset that needs a new processing mode to have stronger decision-making power, insight and discovery capabilities, and process optimization capabilities. With the advent of the cloud era, big data has attracted increasing attention. Big data needs special technologies to effectively process substantial data within a tolerable elapsed time. Technologies applicable to big data include a massively parallel processing database, data mining, a distributed file system, a distributed database, a cloud computing platform, the Internet, and an extensible storage system.

In short, a database can be seen as an electronic file cabinet which is a place where electronic files are stored, and users can perform operations such as adding, querying for, updating, and deletion on data in the files. The so-called “database” is a set of data that is stored together in a manner, may be shared by many users, has as little redundancy as possible, and is independent of application programs.

A database management system (DBMS) is a computer software system designed for managing a database, and generally has basic functions such as storage, interception, security guarantee, and backup. The database management system may be classified based on a database model such as a relationship and an Extensible Markup Language (Extensible Markup Language, XML) supported by it, or based on a supported computer type such as a server cluster or a mobile phone supported by it; or based on a used query language such as a structured query language (SQL) or XQuery; or based on a performance impulse focus such as a maximum scale and a highest running speed; or in another classification manner. Regardless of which classification manner is used, some DBMSs may be cross-category, for example, supporting a number of query languages at the same time.

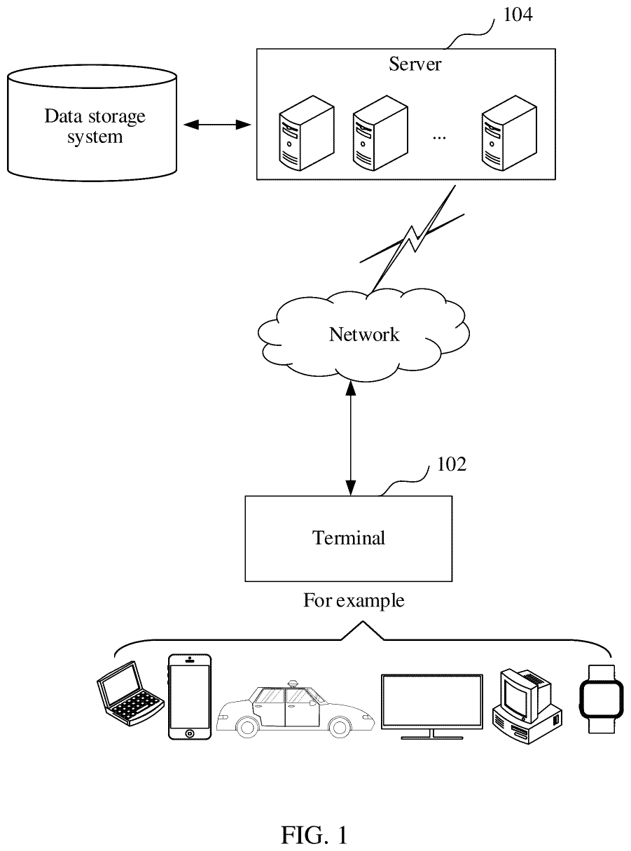

A data table processing method provided in an embodiment of the present disclosure can be applied to an application environment shown in FIG. 1. A terminal 102 communicates with a server 104 through a network. A data storage system may store data that needs to be processed by the server 104. The data storage system may be integrated on the server 104, or placed on a cloud or other servers. Both the terminal 102 and the server 104 may be separately configured to perform the data table processing method provided in this embodiment of the present disclosure. The terminal 102 and the server 104 may further be cooperatively configured to perform the data table processing method provided in this embodiment of the present disclosure. When the terminal 102 and the server 104 may further be cooperatively configured to perform the data table processing method provided in this embodiment of the present disclosure, the terminal 102 obtains a source data table and transmits the source data table to the server 104. The server 104 obtains source table structure information of the source data table, changes the source table structure information, and creates a target data table based on changed table structure information. The server 104 determines a plurality of source primary key values in the source data table, each source primary key value being configured for identifying a piece of source data in the source data table. The server 104 successively migrates the source primary key values and the source data in the source data table to the target data table, at least one source primary key value and the source data identified by the at least one source primary key value being migrated each time, and each migration starting after previous migration succeeds. The server 104 generates a migration progress record for a source primary key value of each migration. When migration interruption occurs, the server 104 determines a migration progress record at the migration interruption, and determines a source primary key value at the migration interruption in the source data table based on the migration progress record at the migration interruption. The server 104 continues to successively migrate, from the source primary key value at the migration interruption in the source data table, an unmigrated source primary key value and unmigrated source data in the source data table to the target data table.

In various embodiments in the present disclosure, “when migration interruption occurs” may be rephrased as “in response to migration interruption occurring” or the like. In some implementations, migration interruption may occur when migration is unable to be performed successfully.

In various embodiments in the present disclosure, a “migration progress record at the migration interruption” may be rephased as “migration interruption record”. In some implementations, migration interruption record may be a particular migration progress record at the migration interruption when migration interruption occurs.

The terminal 102 may be, but is not limited to, various desk computers, notebook computers, smart phones, tablet computers, smart voice interaction devices, smart appliances, in-vehicle terminals, aircrafts, and the like. An application program may be run on the terminal 102. The application program may be a communication application, an audio/video application, an image processing application, or the like. The server 104 may be an independent physical server, or may be a server cluster or a distributed system formed by a plurality of physical servers, or may be a server that provides basic cloud computing services such as cloud services, cloud databases, cloud computing, cloud functions, cloud storage, network services, cloud communication, middleware services, domain name services, security services, content delivery networks (CDNs), big data, and artificial intelligence platforms.

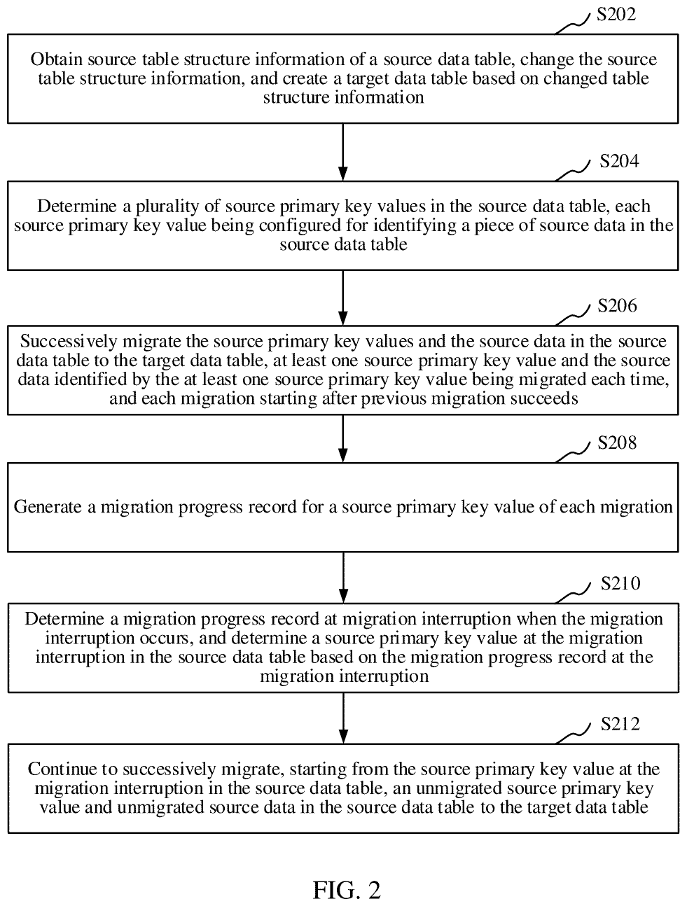

In an embodiment, as shown in FIG. 2, a data table processing method is provided. An example in which the method is applied to a computer device (the computer device may be the terminal or the server in FIG. 1) is used for description, including the following operations:

Operation S202: Obtain source table structure information of a source data table, change the source table structure information, and create a target data table based on changed table structure information.

The source data table is a data table on which data migration needs to be performed. A “column” of the data table is referred to as a “field”, and one field may include a type of information. A field name may be a column name of each column in the data table, and is configured for describing an attribute shared by data in this column. The attribute may be specifically at least one of a meaning or a use of the data. For example, an “address book” data table includes field names such as “name” and “contact number”. Field content refers to specific data in each column in the data table. For example, each piece of data in a column of data with a field name of “name” is used as field content, for example, including “Zhang XX”, “Li XX”, and the like.

The source table structure information is related information for describing a table structure of the source data table. The table structure of the source data table is a data structure of the source data table, and is a manner for a computer to store and organize data. The data structure is a set of data with one or more specific relationships. The source table structure information includes at least one of information such as a table name, a number of fields, a field name, a field type, a data length, a primary key, a foreign key, or an index of the source data table.

The target data table is a data table that receives migrated data of the source data table. The changed table structure information may be referred to as target table structure information, and the target data table is a data table with a target table structure. The target table structure is a data structure of the target data table. The changed table structure information includes at least one of information such as a table name, a number of fields, a field name, a field type, a data length, a primary key, a foreign key, or an index of the target data table.

In this embodiment, the source table structure information is different from the changed table structure information. That the source table structure information is different from the changed table structure information may be specifically that at least one of the table name, the number of fields, the field name, the field type, the data length, the primary key, the foreign key, or the index is different.

In this embodiment, the computer device may determine the source data table on which data migration needs to be performed and obtain the source table structure information of the source data table. The computer device changes the source table structure information, to obtain the changed table structure information. The computer device may create the target data table based on the changed table structure information. The changed table structure information may be referred to as target table structure information, and then the created target data table has a target table structure.

For example, the source table structure information defines that the source data table includes three fields with field names of field 1, field 2, and field 3 respectively. The computer device changes the source table structure information, to add a new field, and obtained target table structure information includes four fields with field names of field 1, field 2, field 3, and field 4 respectively.

In an embodiment, the computer device changes the source table structure information, to obtain the changed table structure information. The computer device may create an empty target data table based on the changed table structure information. The empty target data table has a target table structure.

In an embodiment, when there are a plurality of source data tables on which data migration needs to be performed, the computer device may determine a source table structure of each source data table. When the source table structures of the plurality of source data tables are the same, a target data table with a target table structure is generated based on the source table structures of the plurality of source data tables.

In this embodiment, when the source table structures of the plurality of source data tables are different, the source table structures of the plurality of source data tables are adjusted to generate a plurality of data tables with the same structure, and then a target data table with a target table structure is generated based on the plurality of data tables with the same structure.

Operation S204: Determine a plurality of source primary key values in the source data table, each source primary key value being configured for identifying a piece of source data in the source data table.

One data table has one primary key. One primary key may have a plurality of primary key values. Each primary key value is configured for uniquely identifying one record in the data table. The primary key of the source data table is a source primary key, and the source primary key has a plurality of source primary key values. The plurality of source primary key values are different from each other. To be specific, the plurality of source primary key values are not the same value. For example, three source primary key values are respectively 1, 2, and 3.

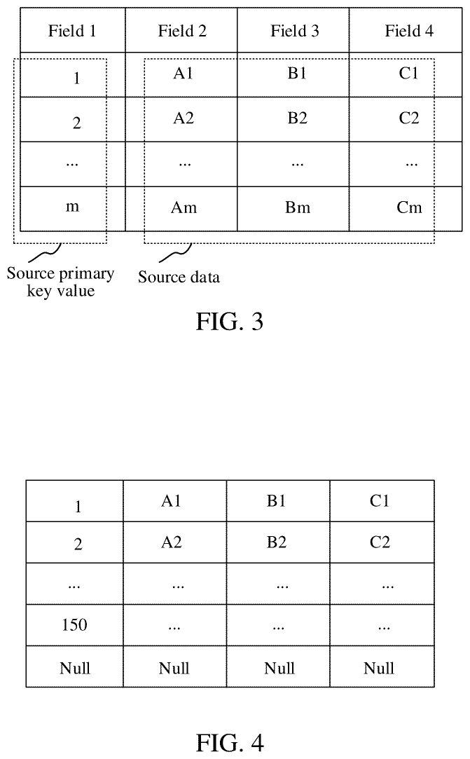

The plurality of source primary key values are configured for respectively identifying different source data in the source data table. Each source primary key value is configured for uniquely identifying a piece of source data in the source data table. The source data is a record in the source data table. For example, the source data is data in a row of data in the source data table except the source primary key value of this row, as shown in FIG. 3.

In this embodiment, the computer device may determine the source primary key in the source data table, and determine the plurality of source primary key values of the source primary key. One source primary key value is configured for identifying a piece of source data in the source data table.

For example, one source data table has five columns of data, and the five columns of data form four rows of data. A first column is a primary key column. An element in each row of the first column is a source primary key value, and a source primary key value in the first column is configured for identifying source data in a first row. The source data in the first row is an element in the first row of columns from two to five.

Operation S206: Successively migrate the source primary key values and the source data in the source data table to the target data table, at least one source primary key value and the source data identified by the at least one source primary key value being migrated each time, and each migration starting after previous migration succeeds.

In this embodiment, the computer device may successively migrate the source primary key values and the source data identified by the source primary key values in the source data table to the target data table in a migration manner of migrating at least one source primary key value and source data identified by the at least one source primary key value each time. In one migration, at least one source primary key value and source data identified by the at least one source primary key value may be migrated. In addition, each migration starts after the previous migration succeeds.

For example, one source primary key value and source data identified by the source primary key value are migrated each time, and after current migration succeeds, next migration is performed. Or, the computer device migrates a preset number of source primary key values and source data identified by the preset number of source primary key values each time.

Operation S208: Generate a migration progress record for a source primary key value of each migration.

The migration progress record is configured for recording a progress of data migration in the source data table. The migration progress record may include at least one of the following: a migrated source primary key value, a position of the migrated source primary key value in the source data table, migration time, a migration state, and the like. The migration time may specifically include at least one of the following: migration initiation time and migration end time. The migration state is configured for representing a migration success or a migration failure. The migration state may be represented through a preset state bit, and different migration states may be represented through different preset state bits. For example, the migration succeed is represented by 1, and the migration failure is represented by 0. This may be specifically set according to a requirement.

The migration progress record formed during each migration may record a migration state of each source primary key value of each migration. For example, 50 rows of data are migrated each time from the source data table, the migration progress record formed by migrating first to 50^{th} rows may record a migration state of a source primary key value of each row, for example, migration of the first row succeeds, migration of the second row succeeds, . . . , and migration of the 50^{th} row succeeds. In the process of migrating 51^{st} to 100^{th} rows, the migrations of the 51^{st} to 60^{th} rows succeed and the migration of the 61^{st} row fails, a migration progress record of this time is as follows: the migration of the 51^{st} row succeeds, the migration of the 52^{nd} row succeeds, . . . , and the migration of the 61^{st} row fails.

The migration progress record formed during each migration may record only one migration state in each migration. For example, the migration progress record formed by migrating the first to 50^{th} rows is “migration succeeds”, indicating that data in the first to 50^{th} rows is migrated successfully. The migration progress record formed by migrating the 51^{st} to 100^{th} rows is “migration fails”, indicating that an interruption occurs in the migration of the data in the 51^{st} to 100^{th} rows. Subsequently, a specific row of data in which the interruption occurs may be determined, to determine a source primary key value at the migration interruption, or the source primary key value of the 51^{st} row may be used as a source primary key value at the migration interruption.

In other embodiments, the migration progress record may specifically record a migration progress of the source primary key value and the source data of each migration.

In this embodiment, in each data migration, the computer device may generate the migration progress record for each data migration. The migration progress record may be generated each time after data is migrated to the target data table, or may be generated each time before data is migrated to the target data table.

The migration progress record may be generated each time after data is migrated to the target data table. For example, a source primary key value of a first row of data is “1”. After the first row of data is migrated to the target data table, a migration progress record of, for example, “1 migration succeeds” is generated.

When the migration progress record is generated each time after data is migrated to the target data table, each migration progress record may record a source primary key value of source data that is migrated successfully, or a position of the source primary key value in the source data table.

That the migration progress record is generated each time before data is migrated to the target data table is that the migration progress record may be generated after data for current migration is determined and is not migrated to the target data table. The migration progress record may record a source primary key value of source data that needs to be migrated this time, or a position of the source primary key value in the source data table. For example, if the computer device determines that first to third rows of data need to be migrated this time, after the first to third rows of data are copied, the computer device generates a migration progress record of “the first to third rows are migrated”, and then migrates the data to the target data table.

Operation S210: Determine, when migration interruption occurs, a migration progress record at the migration interruption, and determine a source primary key value at the migration interruption in the source data table based on the migration progress record at the migration interruption.

The migration interruption refers to an interruption occurring in the process of migrating the source primary key values and the source data from the source data table to the target data table. The migration interruption may be caused by factors such as a computer hardware or software fault, human interference, or the like.

In this embodiment, when the migration interruption occurs in the data migration process of the source data table, the computer device may determine the migration progress record at the migration interruption from the migration progress records of each migration, and determine the source primary key value at the migration interruption in the source data table based on the migration progress record at the migration interruption.

In this embodiment, the source primary key values of each migration are recorded in the migration progress records of each migration. The computer device may determine the migration progress record at the migration interruption and determine the source primary key value recorded in the migration progress record. The recorded source primary key value is used as the source primary key value at the migration interruption in the source data table.

In this embodiment, when a plurality of source primary key values are recorded in the migration progress record at the migration interruption, respective positions of the plurality of source primary key values in the source data table may be determined. The source primary key value at the migration interruption in the source data table is determined based on the positions.

When a plurality of source primary key values and a plurality of migration states are recorded in the migration progress record at the migration interruption, and one source primary key value corresponds to one migration state, a migration state representing a migration failure in the migration progress record may be determined. The source primary key value corresponding to the migration state representing the migration failure is used as the source primary key value at the migration interruption.

In an embodiment, when migration states of a plurality of source primary key values are recorded in the migration progress record at the migration interruption, and the migration states of the plurality of source primary key values indicate migration successes, a next source primary key value of a source primary key value with a smallest position in the source data table may be determined based on positions of the plurality of source primary key values in the source data table, and the next source primary key value is used as the source primary key value at the migration interruption.

For example, three source primary key values are recorded in the migration progress record at the migration interruption, and the three source primary key values are respectively located in the 51^{st} row, the 52^{nd} row, and the 53^{rd} row in the source data table. The source primary key value of the 51^{st} row may be used as the source primary key value at the migration interruption. When migration states corresponding to the three source primary key values are also recorded in the migration progress record, such as: migration of the 51^{st} row succeeds, migration of the 52^{nd} row succeeds, and migration of the 53^{rd} row fails, the source primary key value of the 53^{rd} row may be used as the source primary key value at the migration interruption.

When the migration progress record at the migration interruption is as follows: the migration of the 51^{st} row succeeds, the migration of the 52^{nd} row succeeds, and the migration of the 53^{rd} row succeeds, the source primary key value of the 54^{th} row is used as the source primary key value at the migration interruption.

Operation S212: Continue to successively migrate, starting from the source primary key value at the migration interruption in the source data table, an unmigrated source primary key value and unmigrated source data in the source data table to the target data table.

In this embodiment, after the source primary key value at the migration interruption in the source data table is determined, the computer device continues to migrate, starting from the source primary key value at the migration interruption in the source data table, the unmigrated source primary key value and the unmigrated source data in the source data table to the target data table based on the migration manner of migrating at least one source primary key value and source data identified by the at least one source primary key value each time. Similarly, in one migration, at least one source primary key value and source data identified by the at least one source primary key value may be migrated.

In this embodiment, after the source primary key value at the migration interruption in the source data table is determined, the computer device continues to migrate, starting from the source primary key value at the migration interruption in the source data table, the unmigrated source primary key value and the unmigrated source data in the source data table to the target data table based on a manner of migrating a preset number of source primary key values and source data identified by the preset number of source primary key values each time.

In this embodiment, in the process of continuing the migration from the source primary key value at the migration interruption, each migration also starts after the previous migration succeeds.

In the above data table processing method, the source table structure information of the source data table is obtained, and the source table structure information is changed, to obtain new table structure information. The target data table is created based on the changed table structure information, to obtain a new data table with a table structure different from that of the source data table, thereby determining a data migration source and a data receiver. The plurality of source primary key values in the source data table are determined. Each source primary key value is configured for identifying a piece of source data in the source data table, to implement migration of different source data. The source primary key values and the source data in the source data table are successively migrated to the target data table based on the migration manner of migrating at least one source primary key value and source data identified by the at least one source primary key value each time, so that at least one source primary key value and at least one piece of source data can be migrated each time. In addition, each migration starts after the previous migration succeeds, to ensure that each migration is performed after the previous migration succeeds, thereby ensuring continuity and accuracy of data migration. The migration progress record is generated for the source primary key value of each migration, so that in a case that the migration interruption occurs, the migration progress record at the migration interruption can be obtained, to determine successfully migrated data and unsuccessfully migrated data in the source data table. The source primary key value at the migration interruption in the source data table is determined based on the migration progress record at the migration interruption, so that starting from the source primary key value at the migration interruption in the source data table, the unmigrated source primary key value and the unmigrated source data in the source data table can be continued to be successively migrated to the target data table, without performing data migration from the beginning, thereby solving a problem of low data migration efficiency caused by performing data migration from the beginning in case of a table structure change failure in a conventional solution, and effectively improving the data migration efficiency.

In an embodiment, the source primary key values in the source data table are used as target primary key values in the target data table; and the determining a migration progress record at migration interruption when the migration interruption occurs, and determining a source primary key value at the migration interruption in the source data table based on the migration progress record at the migration interruption includes:

determining the migration progress record at the migration interruption when the migration interruption occurs, and querying for a target primary key value at the migration interruption in the target data table; updating the migration progress record at the migration interruption based on the target primary key value; and determining the source primary key value at the migration interruption in the source data table based on an updated migration progress record.

In this embodiment, the computer device uses the source primary key in the source data table as a target primary key in the target data table, uses the source primary key values in the source data table as target primary key values in the target data table, and uses the source data in the source data table as target data in the target data table. The target primary key has a plurality of target primary key values, and the plurality of target primary key values are configured for respectively identifying different target data in the target data table. One target primary key value is configured for identifying a piece of target data in the target data table.

In an embodiment, the target primary key in the target data table is an explicit primary key.

In an embodiment, the computer device successively migrates the source primary key values and the source data in the source data table to the target data table in the migration manner of migrating at least one source primary key value and source data identified by the at least one source primary key value each time, and uses the source primary key value of each migration as the target primary key value in the target data table.

When the migration interruption occurs in the data migration process of the source data table, the computer device may determine the migration progress record at the migration interruption from the migration progress records of each migration, and query for the target primary key value at the migration interruption in the target data table; and update the migration progress record at the migration interruption based on the target primary key value, to obtain the updated migration progress record.

In this embodiment, the updating the migration progress record at the migration interruption may be specifically updating the source primary key value in the migration progress record, or updating a position recorded in the migration progress record. The position recorded in the migration progress record is a position of the migrated source primary key value in the source data table.

In this embodiment, the source primary key values of each migration are recorded in the migration progress record generated each time. The computer device queries for the target primary key value at the migration interruption in the target data table, and replaces the source primary key value in the migration progress record with the target primary key value in the target data table when the target primary key value at the migration interruption in the target data table is inconsistent with the source primary key value in the migration progress record at the migration interruption, to obtain the updated migration progress record. The computer device searches the source data table for the updated source primary key value, and uses the updated source primary key value as the source primary key value at the migration interruption in the source data table.

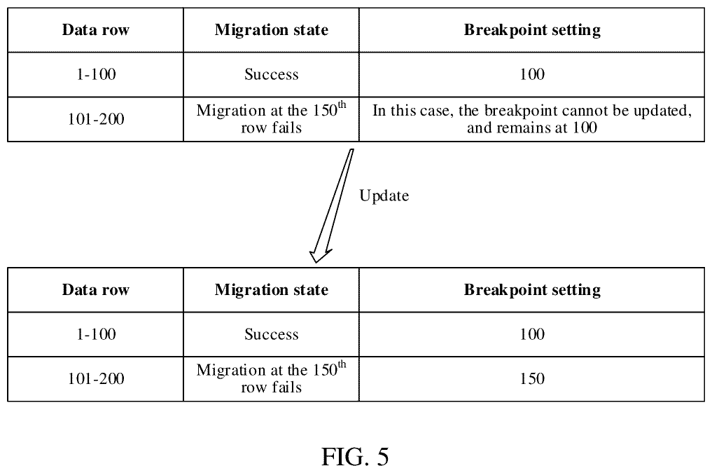

In this embodiment, the computer device may determine a maximum target primary key value at the migration interruption in the target data table, and replace the source primary key value in the migration progress record at the migration interruption with the maximum target primary key value, to obtain the updated migration progress record. As shown in FIG. 4, at the migration interruption, the maximum target primary key value in the target data table is 150, namely, the migration is performed to a 150^{th} row. As shown in FIG. 5, if the source primary key value recorded in the migration progress record at the migration interruption is 100, the source primary key value recorded in the migration progress record may be updated from 100 to 150, so that subsequent migration continues from data in the 150^{th} row.

In an embodiment, a position of the source primary key value at the migration interruption in the source data table is recorded in the migration progress record at the migration interruption. The computer device updates the position in the migration progress record based on the target primary key value. The computer device searches the source data table for an updated position in the migration progress record, and uses the source primary key value at the updated position as the source primary key value at the migration interruption.

In this embodiment, the source primary key values in the source data table are used as the target primary key values in the target data table. When the migration interruption occurs, the migration progress record at the migration interruption is determined, and the target primary key value at the migration interruption in the target data table is queried for. The target primary key value is a boundary point between a data migration success and a data migration failure. Therefore, when the migration progress record at the migration interruption is updated based on the target primary key value, the source primary key value, recorded in the migration progress record, at the migration interruption is more accurate. Therefore, data migration can be continued to be performed from the source primary key value at the migration interruption in the source data table, and a migration initiation position for another migration can be accurately determined. It is avoided that some data that is successfully migrated needs to be migrated again, which helps improve accuracy of data migration and a migration speed.

In an embodiment, the migration progress record is stored in a progress data table; and the determining the source primary key value at the migration interruption in the source data table based on an updated migration progress record includes:
determining a composite primary key in the progress data table, the composite primary key being a combination of a table name of the source data table and a database name of a database, and the database being configured for storing the source data table; and determining the source primary key value at the migration interruption in the source data table based on the composite primary key and the updated migration progress record.

The progress data table is a data table for storing the migration progress record. The composite primary key is a primary key of the progress data table, and the composite primary key is formed by a plurality of fields in the progress data table. For example, a table field name and a database field name in the progress data table are jointly configured as a primary key, thus obtaining the composite primary key of the progress data table. The table field name and the database field name are configured as the composite primary key, namely, table field content in the table field name and database field content in the database field name are used as the composite primary key.

In this embodiment, the computer device writes the migration progress record generated in each migration into the progress data table, or the computer device generates a migration progress record in the progress data table based on a source primary key value of source data migrated each time.

When the migration interruption occurs, the computer device determines the composite primary key in the progress data table, and queries for, based on the composite primary key, the source data table in which the migration interruption occurs and a database that stores the source data table.

The computer device queries for the migration progress record at the migration interruption from the progress data table, to determine the target primary key value at the migration interruption in the target data table, and updates the migration progress record at the migration interruption based on the target primary key value, to obtain the updated migration progress record.

The computer device queries for the source data table in the database based on the composite primary key, to determine the source primary key value at the migration interruption in the source data table based on the updated migration progress record, and continues to perform data migration from the source primary key value at the migration interruption in the source data table of the database.

In this embodiment, the composite primary key in the progress data table is determined. The composite primary key is a combination of the table name of the source data table and the database name of the database. The database is configured for storing the source data table, so as to determine a data table in which the migration interruption occurs and a database that stores the data table in which the migration disruption occurs, thereby quickly locating a data table in which the migration interruption occurs in a particular database. After the source primary key value at the migration interruption in the source data table is determined based on the composite primary key and the updated migration progress record, data migration of the data table of the database can be continued to be performed, and accuracy of data migration can be ensured.

In an embodiment, the method further includes:
obtaining the table name of the source data table, and determining the database name of the database that stores the source data table; constructing the progress data table, the progress data table including a table field name, a database field name, and a record field name, the migration progress record being used as record field content of the record field name; using the table name of the source data table as table field content in the table field name, and using the database name of the database as database field content in the database field name; and configuring the table field content and the database field content as the composite primary key of the progress data table.

In this embodiment, the computer device obtains the table name of the source data table, determines the database that stores the source data table, and obtains the database name of the database. The computer device constructs the progress data table. The constructed progress data table includes the table field name, the database field name, and the record field name. The table name of the source data table is used as the table field content in the table field name, and the database name of the database is used as the database field content in the database field name. The computer device configures the table field name and the database field name as the composite primary key of the progress data table, namely, configures the table field content and the database field content as the composite primary key of the progress data table.

Each time data is migrated from the source data table, the generated migration progress record is written into the record field name of the progress data table, namely, the migration progress record is used as the record field content of the record field name.

For example, a progress data table t_ddl_break_point is configured for persistently recording a breakpoint K, and the breakpoint K is the source primary key value at the migration interruption. The t_ddl_break_point is defined as follows:
CREATE TABLE t_ddl_break_point (
db_name VARCHAR (256), //execute ddl database name
table_name VARCHAR (256), //execute ddl table name
break_point VARCHAR (256), //record a breakpoint, where the breakpoint may be of various data types;
PRIMARY KEY (db_name, table_name)//the database name and the table name constitute the composite primary key, to quickly identify a table that requires breakpoint resume):
);

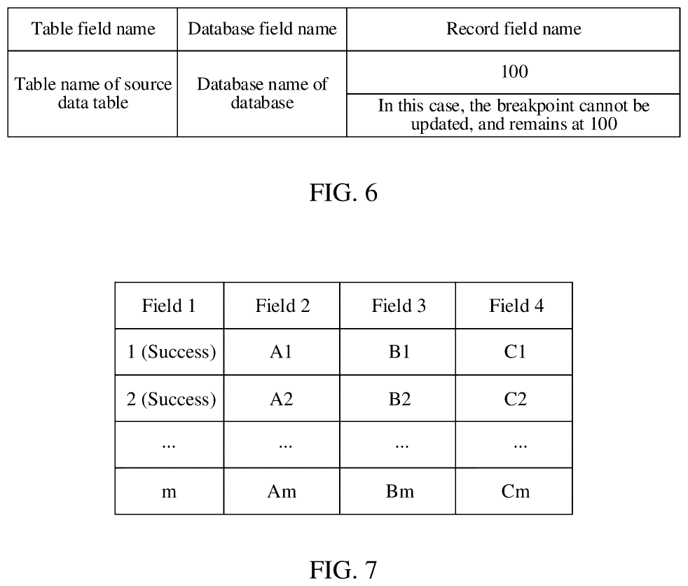

The generated progress data table is shown in FIG. 6. The progress data table includes a table field name, a database field name, a record field name, and the like.

In this embodiment, the table name of the source data table is obtained. The database name of the database that stores the source data table is determined, to construct the progress data table. The progress data table includes the table field name, the database field name, and the record field name. The migration progress record is used as the record field content of the record field name, so that the migration progress record can be found in the progress data table. The table name of the source data table is used as the table field content in the table field name; the database name of the database is used as the database field content in the database field name; and the table field content and the database field content are configured as the composite primary key of the progress data table, so that a data table that requires breakpoint resume can be quickly identified.

In an embodiment, the successively migrating the source primary key values and the source data in the source data table to the target data table includes:
determining respective migration orders of the plurality of source primary key values based on positions of the plurality of source primary key values in the source data table; and successively migrating the source primary key values and the source data in the source data table to the target data table based on the migration orders of the plurality of source primary key values.

In this embodiment, the computer device may determine the position of each source primary key value in the source data table, and determine the respective migration orders of the plurality of source primary key values based on the positions of the plurality of source primary key values in the source data table; and successively migrate the source primary key values and the source data in the source data table to the target data table based on the migration orders of the plurality of source primary key values.

In this embodiment, the respective migration orders of the plurality of source primary key values are determined based on the positions of the plurality of source primary key values in the source data table, to successively migrate the source primary key values and the source data in the source data table to the target data table based on the respective migration orders of the plurality of source primary key values. This can ensure that orders of migrated source data are not disrupted, thereby ensuring data accuracy.

In an embodiment, the method further includes: determining a position of each source primary key value of each migration in the source data table, and adding the migration progress record of each migration to the position.

The determining a migration progress record at migration interruption when migration interruption occurs, and determining a source primary key value at the migration interruption in the source data table based on the migration progress record at the migration interruption includes: determining, from the source data table, a position of the migration progress record at the migration interruption when the migration interruption occurs; and using the source primary key value at the position of the migration progress record at the migration interruption as the source primary key value at the migration interruption in the source data table.

In this embodiment, the computer device may determine the position of the source primary key value of the source data of each migration in the source data table, and add the migration progress record to the position in the source data table after the migration progress record is generated, to indicate the source primary key value of each data migration.

As shown in FIG. 7, after source data identified by source primary key value 1 is migrated successfully, a migration progress record “success” is added to the position of source primary key value 1.

In this embodiment, the migration progress record may be represented through a preset state bit, and a migration state of the source primary key value and the source data may be represented through the preset state bit. For example, if preset state bit “1” is added to the position of source primary key value 1, it indicates that the migration of the source primary key value and the source data succeeds. If preset state bit “0” is added to the position of source primary key value 1, it indicates that the migration of the source primary key value and the source data fails.

In this embodiment, before or after each migration, a migration progress record may be added to a position of a corresponding source primary key value.

In this embodiment, when the migration interruption occurs, the computer device queries for the source primary key values in the source data table to determine source primary key values having migration progress records, determines, from these migration progress records, the migration progress record at the migration interruption, and determines the position of the migration progress record at the migration interruption.

In this embodiment, the source primary key value at the position of the migration progress record at the migration interruption is determined, and the source primary key value is used as the source primary key value at the migration interruption in the source data table.

In this embodiment, the position, in the source data, of the source primary key value of the source data of each migration is determined, and the migration progress record is added to the position, so that data that has been migrated and data that has not been migrated in the source data table can be directly marked. Furthermore, when the migration interruption occurs, the position of the migration progress record at the migration interruption may be quickly and accurately determined from the source data table, and the source primary key value at the position of the migration progress record at the migration interruption is used as the source primary key value at the migration interruption, so that data migration can be continued to be performed from this position, thereby avoiding a situation in which all pieces of data need to be remigrated due to the migration interruption.

In an embodiment, the source primary key values and the source data in the source data table are stored in a form of key-value pairs; and the source primary key values are used as keys, and the source data identified by the source primary key values is used as values corresponding to the keys. The method further includes: determining index data of each key-value pair in the source data table, the index data including the source primary key value and the source data in the key-value pair; and adding the migration progress record that is generated for each source primary key value of each migration into the index data of the key-value pair to which the source data of each migration belongs.

The determining a migration progress record at migration interruption when the migration interruption occurs, and determining a source primary key value at the migration interruption in the source data table based on the migration progress record at the migration interruption includes: querying for the index data of each key-value pair when the migration interruption occurs, to obtain index data to which the migration progress record at the migration interruption belongs; and using the source primary key value included in the obtained index data as the source primary key value at the migration interruption in the source data table.

The source primary key values and the source data in the source data table are stored in the form of the key-value pairs. The source primary key values are used as the keys, and the source data identified by the source primary key values used as the keys is used as the values corresponding to the keys. The index data is information for querying for the source primary key values and the source data from the source data table. One piece of index data includes the source primary key value and the source data in one key-value pair. Each key-value pair corresponds to different index data.

In this embodiment, the index data is also stored in a form of a key-value pair. The index data includes index key data and index value data. A key is the index key data, and a value is the index value data.

In this embodiment, the computer device determines each key-value pair in the source data table. For each key-value pair, the computer device determines the index data corresponding to the key-value pair. The index data corresponding to the key-value pair includes the key and the value in the key-value pair, namely, includes the source primary key value used as the key and the source data used as the value in the key-value pair.

In this embodiment, for each migration, the index data of the key-value pair to which the source data of the migration belongs is determined. After the migration progress record is generated based on the source primary key value of the migration, the migration progress record is added into the index data of the key-value pair to which the source data of the migration belongs.

In this embodiment, the index data includes the index key data and the index value data, and the computer device adds the migration progress record generated in the migration into the index key data or the index value data included in the corresponding index data.

When the migration interruption occurs, the computer device queries for the index data of each key-value pair, to obtain the index data to which the migration progress record at the migration interruption belongs.

Further, at the migration interruption, the computer device sequentially traverses the index data of each key-value pair. When there is a migration progress record in currently traversed index data and there is no migration progress record in index data behind the currently traversed index data, the currently traversed index data is used as the index data to which the migration progress record at the migration interruption belongs.

In this embodiment, the computer device determines the index data to which the migration progress record at the migration interruption belongs, determines the source primary key value included in the index data, and uses the source primary key value as the source primary key value at the migration interruption.

In this embodiment, the source primary key values and the source data in the source data table are stored in the form of the key-value pairs. The source primary key values are used as the keys, and the source data identified by the source primary key values is used as the values corresponding to the keys, so that a corresponding value can be obtained based on each key. The index data of each key-value pair in the source data table is determined. The index data includes the source primary key value and the source data in the key-value pair. The migration progress record generated for the source primary key value of each migration is added into the index data of the key-value pair to which the source data of each migration belongs, so that the migration progress record can be added into the index data, to directly mark data that has been migrated. In this way, when the migration interruption occurs, the index data of each key-value pair can be queried for, and the index data to which the migration progress record at the migration interruption belongs can be quickly and accurately determined, thereby quickly and accurately locating the source primary key value at the migration interruption in the source data table.

In an embodiment, the index data includes index key data; the index key data includes the source primary key value and the source data in the key-value pair; and the adding the migration progress record that is generated for each source primary key value of each migration into the index data of the key-value pair to which the source data of each migration belongs includes: determining index key data to which the source data of each migration belongs; and using the migration progress record that is generated for each source primary key value of each migration as index value data of the index key data to which the source data of each migration belongs.

The querying for the index data of each key-value pair when the migration interruption occurs, to obtain index data to which the migration progress record at the migration interruption belongs includes: querying for each piece of index value data based on each piece of index key data when the migration interruption occurs, to obtain index value data at the migration interruption.

The using the source primary key value included in the obtained index data as the source primary key value at the migration interruption in the source data table includes: using the source primary key value included in the index key data of the obtained index value data as the source primary key value at the migration interruption in the source data table.

The index data includes the index key data, and the index key data includes the source primary key value and the source data that are in the key-value pair.

In this embodiment, in each migration, the computer device determines the index key data to which the source data of each migration belongs. The computer device generates the migration progress record based on the source primary key value of the source data of each migration, to obtain the migration progress record of each migration.

The computer device uses the migration progress record of each migration as the index value data corresponding to the index key data to which the source data of each migration belongs, so that each piece of index data includes the index key data and the index value data, and the index value data is the migration progress record.

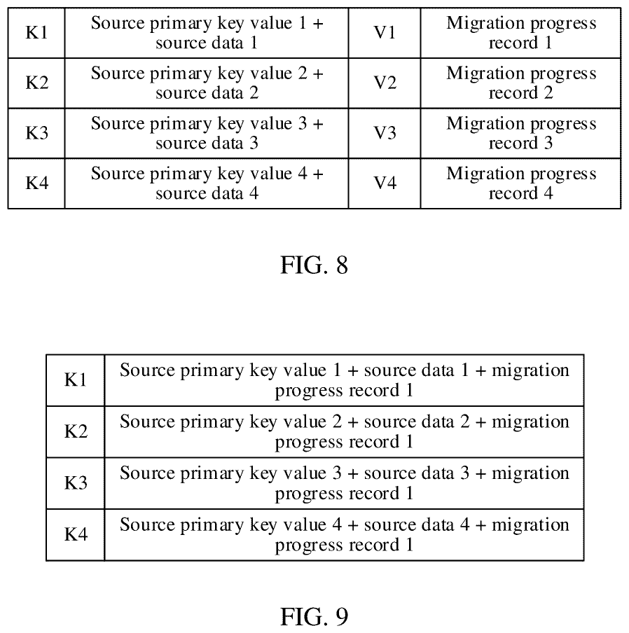

As shown in FIG. 8, if source primary key value 1 identifies source data 1, index key data K1 is: source primary key value 1+source data 1. After this piece of data is migrated, migration progress record 1 is used as index value data V1 corresponding to index data K1. If source primary key value 2 identifies source data 2, index key data K2 is: source primary key value 2+source data 2. After this piece of data is migrated, migration progress record 2 is used as index value data V2 corresponding to index data K2.

If source primary key value 3 identifies source data 3, index key data K3 is: source primary key value 3+source data 3. After this piece of data is migrated, migration progress record 3 is used as index value data V3 corresponding to index data K3.

If source primary key value 4 identifies source data 4, index key data K4 is: source primary key value 4+source data 4. After this piece of data is migrated, migration progress record 4 is used as index value data V4 corresponding to index data K4.

In this embodiment, when the migration interruption occurs, the computer device queries for each piece of index value data based on each piece of index key data, to obtain the index value data at the migration interruption. Further, when the migration interruption occurs, the computer device sequentially traverses each piece of index value data based on an order of each piece of index key data. When currently traversed index key data has index value data and index key data behind the currently traversed index key data does not have corresponding index value data, the index value data corresponding to the currently traversed index key data is used as the index value data at the migration interruption. The index value data at the migration interruption is the migration progress record at the migration interruption.

The computer device determines the index key data corresponding to the index value data at the migration interruption, and determines the source primary key value included in the index key data as the source primary key value at the migration interruption.

In this embodiment, the index key data to which the source data of each migration belongs is determined, and the migration progress record generated based on the source primary key value of the source data of each migration is used as the index value data corresponding to the index key data to which the source data of each migration belongs, so as to directly find, based on index information, data that has been migrated in the source data table. In this way, when the migration interruption occurs, each piece of index value data may be queried for based on each piece of index key data, to quickly obtain the index value data at the migration interruption, thereby quickly determining the source primary key value at the migration interruption.

In an embodiment, the method further includes:

adding the migration progress record that is generated for each source primary key value of each migration into the index key data to which the source data of each migration belongs; querying for each piece of index key data when the migration interruption occurs, to obtain index key data to which the migration progress record at the migration interruption belongs; and determining the source primary key value included in the obtained index key data as the source primary key value at the migration interruption in the source data table.

In this embodiment, the computer device generates the migration progress record of each migration based on the source primary key value of the source data of each migration, and may further add the migration progress record of each migration into index key data to which the source data of each migration belongs.

As shown in FIG. 9, source primary key value 1 identifies source data 1. When no data is migrated, index key data K1 is: source primary key value 1+source data 1. After this piece of data is migrated, migration progress record 1 is added into index key data K1, to form index key data K1: source primary key value 1+source data 1+migration progress record 1. Similarly, index key data K2 is: source primary key value 2+source data 2+migration progress record 2; index key data K3 is: source primary key value 3+source data 3+migration progress record 3; and index key data K4 is: source primary key value 4+source data 4+migration progress record 4.

When the migration interruption occurs, the computer device queries for each piece of index key data, to determine data that has been migrated and data that has not been migrated, so as to obtain the index key data to which the migration progress record at the migration interruption belongs.

Further, the computer device queries for each piece of index key data. When the index key data includes a migration progress record, it indicates that the migration has been performed to the position or the source data indicated by the index key data has been migrated. When the index key data does not include a migration progress record, it indicates that the migration is not performed to the position or is interrupted at the position. When index key data currently queried for includes a migration progress record, and next index key data of the index key data currently queried for does not include a migration progress record, the source primary key value included in the index key data currently queried for is used as the source primary key value at the migration interruption.

In this embodiment, the migration progress record that is generated based on the source primary key value of the source data of each migration is added into the index key data to which the source data of each migration belongs, so that the migration progress record can be added into the index key data of the index data, to directly mark data that has been migrated. In this way, when the migration interruption occurs, the index key data at the migration interruption can be quickly determined by querying for the index key data of the index data, to quickly determine the index key data at the migration interruption, thereby accurately determining the source primary key value at the migration interruption.

In an embodiment, the method further includes:
establishing an association relationship between the source data table and the target data table; recording migration initiation time of the source data table; and performing, when a data processing request for the source data table is received after the migration initiation time, an operation indicated by the data processing request on the source data table, and synchronizing, based on the association relationship, the operation indicated by the data processing request to the target data table.

The association relationship includes at least one of the following: a one-to-one mapping relationship between the plurality of source primary key values in the source data table and the plurality of target primary key values in the target data table, a one-to-one mapping relationship between the plurality of source data and the plurality of target data, a one-to-one mapping relationship between positions of the source primary key values in the source data table and positions of the target primary key values in the target data table, and a one-to-one mapping relationship between positions of the source data in the source data table and positions of the target data in the target data table.

In this embodiment, the computer device may establish the association relationship between the source data table and the target data table. When data migration on the source data table is initiated, the migration initiation time is recorded. The migration initiation time may be a moment at which the data migration on the source data table is initiated for the first time.

When the data processing request for the source data table is received after the migration initiation time, the computer device performs, in the source data table, the operation indicated by the data processing request, and synchronizes, based on the association relationship, the operation indicated by the data processing request to the target data table. To be specific, the operation is performed on both the source data table and the target data table.

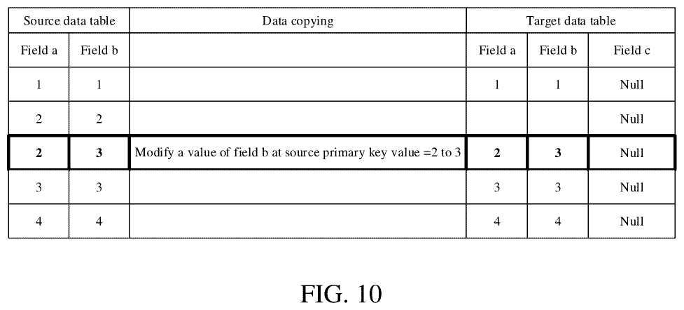

As shown in FIG. 10, before data copying is performed, an association relationship between a source data table t1 and a target data table t1_new is established. Data in the source data table t1 is migrated to the target data table t1_new in a form of Thomas write. In this migration, there may be an access request for the source data table, for example, one or more processing operations such as data insertion, data update, or data deletion. Since the association relationship is established between the source data table t1 and the target data table t1_new, each processing operation on the source data table t1 may be directly synchronized to t1_new.

For example, if time at which the access request occurs is T_ddl, before T_ddl, existing data in the source data table t1 is migrated to the target data table t1_new by means of data copying and backfilling, and after T_ddl, new data generated in the source data table is synchronized to the target data table t1_new by means of writing and forwarding. In this way, it can be ensured that data generated during accessing may not affect the data migration. In addition, the generated new data may be synchronized to the target data table, and there is no data loss problem.

As shown in FIG. 10, in a process of performing data copying based on a data definition language (DDL), for example, data in the source data has been copied to a position at which a source primary key is equal to 4. If a data manipulation language (DML) occurs at this time, b at a primary key=2 is modified into 3. Based on a conventional copying operation, a data modification operation performed by the DML at this time cannot be sensed by the DDL. To be specific, the value of b at the primary key a=2 in the target data table t1_new is still 2, and may not be modified. A data loss problem occurs. In this embodiment, the association relationship between the source data table t1 or t1_old and the target data table t1_new is established, and the data modification operation on the source data table t1_old may be forwarded to the target data table t1_new. Based on the Thomas write rule, the data modification operation may alternatively take effect on t1_new. In this way, it is ensured that DML data is not lost during data copying by the DDL.

In this embodiment, the association relationship between the source data table and the target data table is established; the migration initiation time of the source data table is recorded; data, before the migration initiation time, in the source data table is used as the existing data, and data, generated after the migration initiation time, is used as new data. When the data processing request for the source data table is received after the migration initiation time, the operation indicated by the data processing request is performed on the source data table, and the operation indicated by the data processing request is synchronized to the target data table based on the association relationship, so that normal access to the source data table can be allowed during the data migration. In addition, it can be ensured that data generated during the accessing may not affect the data migration, and generated new data may be synchronized to the target data table, so that the data loss problem does not exist.

In an embodiment, the performing, when a data processing request for the source data table is received after the migration initiation time, an operation indicated by the data processing request on the source data table, and synchronizing, based on the association relationship, the operation indicated by the data processing request to the target data table includes:
determining a type of the data processing request when the data processing request for the source data table is received after the migration initiation time; determining, based on the association relationship, a trigger matching the type; and performing the operation indicated by the data processing request on the source data table, and synchronizing, through the trigger matching the type, the operation indicated by the data processing request to the target data table.

In this embodiment, when the data processing request for the source data table is received, the computer device may determine the time at which the data processing request is received. When the time is after the migration initiation time, the computer device determines the type of the data processing request, and determines, based on the association relationship, the trigger matching the type of the data processing request. Through the trigger matching the type of the data processing request, the processing operation indicated by the data processing request is performed in the source data table, and the processing operation is performed in the target data table.

In this embodiment, at least one of an insertion trigger, an update trigger, or a deletion trigger is set for the source data table in advance. The insertion trigger is configured for synchronously inserting, into the target data table, data inserted into the source data table. The update trigger is configured for synchronously updating data updated in the source data table to the target data table. The deletion trigger is configured for synchronously deleting, from the target data table, data deleted from the source data table.

In this embodiment, when the data processing request for the source data table is received after the migration initiation time, the type of the data processing request is determined; the trigger matching the type of the data processing request is determined based on the association relationship; and the processing operation of the data processing request in the source data table is synchronized to the target data table through the trigger matching the type of the data processing request, so that normal access to the source data table can be allowed during the data migration. In addition, it is ensured that data generated during the accessing may not affect the data migration, and generated new data may be synchronized to the target data table, so that the data loss problem does not exist.

In an embodiment, a data table processing method is provided, applied to a computer device and including:
obtaining source table structure information of a source data table, changing the source table structure information, and creating a target data table with a target table structure based on changed table structure information;
establishing an association relationship between the source data table and the target data table, the association relationship including at least one of the following: a one-to-one mapping relationship between a plurality of source primary key values in the source data table and a plurality of target primary key values in the target data table, a one-to-one mapping relationship between a plurality of source data and a plurality of target data, a one-to-one mapping relationship between positions of the source primary key values in the source data table and positions of the target primary key values in the target data table, and a one-to-one mapping relationship between positions of the source data in the source data table and positions of the target data in the target data table;
obtaining a table name of the source data table, and determining a database name of a database that stores the source data table; constructing a progress data table, the progress data table including a table field name, a database field name, and a record field name; using the table name of the source data table as table field content in the table field name, using the database name of the database as database field content in the database field name, and configuring the table field content and the database field content as a composite primary key of the progress data table;
determining the plurality of source primary key values in the source data table, each source primary key value being configured for identifying a piece of source data in the source data table;
determining respective migration orders of the plurality of source primary key values based on the positions of the plurality of source primary key values in the source data table, and successively migrating the source primary key values and the source data in the source data table to the target data table based on the migration orders of the plurality of source primary key values, where at least one source primary key value and the source data identified by the at least one source primary key value are migrated each time, and each migration starts after previous migration succeeds; recording migration initiation time of first migration;
generating a migration progress record based on the source primary key value of the source data of each migration, and writing the migration progress record of each migration into the record field name in the progress data table as record field content of the record field name;
when migration interruption occurs, determining a migration progress record at the migration interruption from the progress data table, and determining a source primary key value at the migration interruption based on the migration progress record at the migration interruption;
determining, based on the composite primary key in the progress data table, the source data table stored in the database, and continuing to successively migrate, starting from the source primary key value at the migration interruption in the source data table, an unmigrated source primary key value and unmigrated source data in the source data table to the target data table, where at least one source primary key value and the source data identified by the at least one source primary key value are migrated each time, and each migration starts after previous migration succeeds;
determining a type of a data processing request when the data processing request for the source data table is received after the migration initiation time, and determining, based on the association relationship, a trigger matching the type of the data processing request; and
performing an operation indicated by the data processing request on the source data table, and synchronizing, through the trigger, the operation indicated by the data processing request to the target data table.

In this embodiment, the target data table obtained by changing a structure of the source data table is obtained, to determine a data migration source and a data receiver. The table name of the source data table is obtained. The database name of the database that stores the source data table is determined, to construct the progress data table. The progress data table includes the table field name, the database field name, and the record field name. The migration progress record is used as the record field content of the record field name, so that the migration progress record can be found in the progress data table. The table name of the source data table is used as the table field content in the table field name; the database name of the database is used as the database field content in the database field name; and the table field content and the database field content are configured as the composite primary key of the progress data table, so that a data table that requires breakpoint resume can be quickly identified.

The plurality of source primary key values in the source data table are determined. The plurality of source primary key values are configured for respectively identifying different source data in the source data table, to implement migration of different source data. The migration orders corresponding to the plurality of source primary key values are determined based on the positions of the plurality of source primary key values in the source data table, to successively migrate the source primary key values and the source data in the source data table to the target data table based on the migration orders corresponding to the plurality of source primary key values. This can ensure that orders of migrated source data are not disrupted, thereby ensuring data accuracy.

In addition, each migration starts after the previous migration succeeds, to ensure that each migration is performed after the previous migration succeeds, thereby ensuring continuity and accuracy of data migration.

The migration progress record is generated based on the source primary key value of the source data of each migration, so that in a case that the migration interruption occurs, the migration progress record at the migration interruption can be obtained, to determine successfully migrated data and unsuccessfully migrated data in the source data table.

The composite primary key in the progress data table is determined. The composite primary key is a combination of the table name of the source data table and the database name of the database. The database is configured for storing the source data table, so as to determine a data table in which the migration interruption occurs and a database that stores the data table in which the migration disruption occurs. After the source primary key value at the migration interruption in the source data table is determined based on the composite primary key and the updated migration progress record, data migration of the data table of the database is continued to be performed, instead of performing migration from the beginning. This effectively solves side effects caused by a table structure change failure and improves data migration efficiency.

In an embodiment, an application scene of a data table processing method is provided, including:

in a database, each table has an explicit or implicit PRIMARY KEY, and the PRIMARY KEY can uniquely identify a field or a combination of fields of a data row in a data table. A general-purpose DDL execution manner is creating a new data table (t_new) based on a new table definition, and then sequentially writing data in a source data table (t_old) into the new data table. In this embodiment, the source data table is stored in a preset storage engine based on a key-value data structure. A plurality of source primary key values of a source primary key are stored in an order, and are sorted in a lexicographical order of data. A scanning stage of data copying is also performed based on the orders of the source primary key values. The data copying is data migration, and data in the source data table is migrated to a target data table.

For example, a plurality of source primary key values in a source data table t1_old are 1 to 10. In a process of migrating data to a target data table t1_new, the data is sequentially migrated based on orders from 1 to 10. When migration fails and is interrupted in a stage, a source primary key value K exists, which divides data that has been migrated and data that has not been migrated. The source primary key value K may be referred to as a breakpoint.

In the process of migrating the data from the source data table t1_old to the target data table t1_new, a source primary key value that has been currently scanned is periodically recorded, and the source primary key value is recorded into a progress recording table t_ddl_break_point.

By setting a breakpoint storage cycle, the progress record table t_ddl_break_point is updated at a regular interval, and an update manner is as follows:

Each time a row of data is scanned from the source data table, a migration progress record is generated, and t_ddl_break_point is updated once, so that breakpoint precision can be controlled at a row level.

Or, a time cycle is set. One migration progress record is generated every time cycle, and t_ddl_break_point is updated once.

Or, a data row range is set. One migration progress record is generated at one data row range, and t_ddl_break_point is updated once. For example, one migration progress record is generated at each migration of 50 rows of data.

Or, an explicit primary key, i.e. a composite primary key, is set in the target data table t1_new. A row on which current migration is performed may be determined by querying for a maximum value among target primary key values in the target data table t1_new, and a latest breakpoint value in t_ddl_break_point may be updated based on the maximum value among the target primary key values.

When migration interruption occurs, a client may receive a failure prompt. In this case, a distributed database system queries, based on database and table names, whether a corresponding breakpoint exists in t_ddl_break_point. If yes, all data rows before the breakpoint are skipped, and data migration continues to be performed from the breakpoint.

The distributed database system mainly includes two main functional modules, a MetaCluster (hereinafter referred to asMC) responsible for management and control of global information, and a HyperNode (hereinafter referred to as HN) responsible for computation and data storage. The HN performs data storage based on a self-developed efficient storage engine TDStop (hereinafter referred to as TS), and data is stored in a distributed manner. Breakpoint information provided by the HyperNode (HN) is directly located from a data layer, so that searching for a data breakpoint can be completed within extremely short time.

In addition, in this embodiment, DML is allowed to be performed during data migration:

before data copying is performed, an association relationship between the source data table t1 and the target data table t1_new is established. Data in the source data table t1 is migrated to the target data table t1_new in a form of Thomas write. In this migration, there may be an access request for the source data table, for example, one or more processing operations such as data insertion, data update, or data deletion. Since the association relationship is established between the source data table t1 and the target data table t1_new, each processing operation on the source data table t1 may be directly synchronized to t1_new.

For example, if time at which the access request occurs is T_ddl, before T_ddl, existing data in the source data table t1 is migrated to the target data table t1_new by means of data copying and backfilling, and after T_ddl, new data generated in the source data table is synchronized to the target data table t1_new by means of writing and forwarding. In this way, it can be ensured that data generated during accessing may not affect the data migration. In addition, the generated new data may be synchronized to the target data table, and there is no data loss problem.

A conventional table structure change can affect an online service, and may cause a data exception. In addition, a table structure change failure of a large table can cause a loss of much time. The data table processing method in this embodiment is a breakpoint resume mechanism, which allows a failure to occur in a table structure change process, so that a database can memorize a progress of table structure change. When the table structure change process exits due to an error, the same table structure change command is executed again. The database can find a position at which the previous execution is interrupted, and a table structure change operation is continued to be performed based on this position, so that a user does not need to worry about side effects caused by a table structure change failure, and does not need to worry about a waste of a large amount of waiting time, thereby improving processing efficiency of table structure change.

Although the operations are displayed sequentially according to the instructions of the arrows in the flowcharts of the embodiments, these operations are not necessarily performed sequentially according to the sequence instructed by the arrows. Unless otherwise explicitly specified in the present disclosure execution of the operations is not strictly limited, and the operations may be performed in other sequences. Moreover, at least some operations in the flowchart involved in the above embodiments may include a plurality of operations or a plurality of stages. The operations or stages are not necessarily executed completely at the same moment and may be executed at different moments. The operations or stages are not necessarily sequentially executed, and may be executed alternately with other operations or at least some operations or stages of other operations.

Based on the same inventive concept, an embodiment of the present disclosure further provides a data table processing apparatus for implementing the above data table processing method. The implementation scheme provided by the apparatus to solve the problems is similar to the implementation scheme recorded in the above method. Therefore, for specific limitations in the one or more embodiments of the data table processing apparatus provided below, refer to the limitations on the data table processing method mentioned above, and details will not be elaborated here.

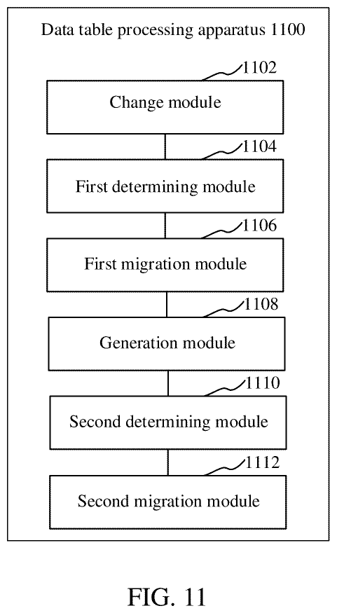

In an embodiment, as shown in FIG. 11, a data table processing apparatus 1100 is provided, including a change module 1102, a first determining module 1104, a first migration module 1106, a generation module 1108, a second determining module 1110, and a second migration module 1112.

The change module 1102 is configured to: obtain source table structure information of a source data table, change the source table structure information, and create a target data table based on changed table structure information.

The first determining module 1104 is configured to determine a plurality of source primary key values in the source data table, each source primary key value being configured for identifying a piece of source data in the source data table.

The first migration module 1106 is configured to successively migrate the source primary key values and the source data in the source data table to the target data table, at least one source primary key value and the source data identified by the at least one source primary key value being migrated each time, and each migration starting after previous migration succeeds.

The generation module 1108 is configured to generate a migration progress record for a source primary key value of each migration.

The second determining module 1110 is configured to: determine a migration progress record at migration interruption when the migration interruption occurs, and determine a source primary key value at the migration interruption in the source data table based on the migration progress record at the migration interruption.

The second migration module 1112 is configured to: continue to successively migrate, starting from the source primary key value at the migration interruption in the source data table, an unmigrated source primary key value and unmigrated source data in the source data table to the target data table.

In this embodiment, the source table structure information of the source data table is obtained; the target data table with the target table structure is created based on the source table structure information, to create a new data table based on the structure information of the source data table; and a data migration source and a data receiver are determined. The plurality of source primary key values in the source data table are determined. The plurality of source primary key values are configured for respectively identifying different source data in the source data table, to implement migration of different source data. The source data in the source data table is successively migrated to the target data table based on the source primary key values in the source data table, and each migration starts after previous migration succeeds, to ensure that each migration is executed after the previous migration succeeds, thereby ensuring continuity and accuracy of data migration. The migration progress record is generated based on the source primary key value of the source data of each migration, so that in a case that the migration interruption occurs, the migration progress record at the migration interruption can be obtained, to determine successfully migrated data and unsuccessfully migrated data in the source data table. The source primary key value at the migration interruption is determined based on the migration progress record at the migration interruption, so that unmigrated data in the source data table can be continued to be migrated to the target data table from the source primary key value at the migration interruption, without performing migration from the beginning, thereby effectively solving a side effect caused by a table structure change failure and improving data migration efficiency.

In an embodiment, the source primary key values in the source data table are used as target primary key values in the target data table. The second determining module 1110 is further configured to: determine the migration progress record at the migration interruption when the migration interruption occurs, and query for a target primary key value at the migration interruption in the target data table; update the migration progress record at the migration interruption based on the target primary key value; and determine the source primary key value at the migration interruption in the source data table based on an updated migration progress record.

In this embodiment, the source primary key values in the source data table are used as the target primary key values in the target data table. When the migration interruption occurs, the migration progress record at the migration interruption is determined, and the target primary key value at the migration interruption in the target data table is queried for. The target primary key value is a boundary point between a data migration success and a data migration failure. Therefore, when the migration progress record at the migration interruption is updated based on the target primary key value, the source primary key value, recorded in the migration progress record, at the migration interruption is more accurate. Therefore, data migration can be continued to be performed from the source primary key value at the migration interruption, and a migration initiation position for another migration can be accurately determined. It is avoided that some data that is successfully migrated needs to be migrated again, which helps improve accuracy of data migration and a migration speed.

In an embodiment, the migration progress record is stored in a progress data table. The second determining module 1110 is further configured to: determine a composite primary key in the progress data table, the composite primary key being a combination of a table name of the source data table and database name of a database, and the database being configured for storing the source data table; and determine the source primary key value at the migration interruption in the source data table based on the composite primary key and the updated migration progress record.

In this embodiment, the composite primary key in the progress data table is determined. The composite primary key is a combination of the table name of the source data table and the database name of the database. The database is configured for storing the source data table, so as to determine a data table in which the migration interruption occurs and a database that stores the data table in which the migration disruption occurs. After the source primary key value at the migration interruption in the source data table is determined based on the composite primary key and the updated migration progress record, data migration of the data table of the database is continued to be performed, and accuracy of data migration can be ensured.

In some embodiments, the apparatus further includes:
a construction module, configured to: obtain the table name of the source data table, and determine the database name of the database that stores the source data table; construct the progress data table, the progress data table including a table field name, a database field name, and a record field name, the migration progress record being used as record field content of the record field name; use the table name of the source data table as table field content in the table field name, and use the database name of the database as database field content in the database field name; and configure the table field content and the database field content as the composite primary key of the progress data table.

In this embodiment, the table name of the source data table is obtained. The database name of the database that stores the source data table is determined, to construct the progress data table. The progress data table includes the table field name, the database field name, and the record field name. The migration progress record is used as the record field content of the record field name, so that the migration progress record can be found in the progress data table. The table name of the source data table is used as the table field content in the table field name; the database name of the database is used as the database field content in the database field name; and the table field content and the database field content are configured as the composite primary key of the progress data table, so that a data table that requires breakpoint resume can be quickly identified.

In an embodiment, the first migration module 1106 is further configured to determine respective migration orders of the plurality of source primary key values based on positions of the plurality of source primary key values in the source data table; and successively migrate the source primary key values and the source data in the source data table to the target data table based on the migration orders of the plurality of source primary key values.

In this embodiment, the migration orders corresponding to the plurality of source primary key values are determined based on the positions of the plurality of source primary key values in the source data table, to successively migrate the source primary key values and the source data in the source data table to the target data table based on the migration orders corresponding to the plurality of source primary key values. This can ensure that orders of migrated source data are not disrupted, thereby ensuring data accuracy.

In some embodiments, the apparatus further includes:
an adding module, configured to: determine a position of each source primary key value of each migration in the source data table, and add the migration progress record of each migration to the position.

The second determining module 1110 is further configured to: determine, from the source data table, a position of the migration progress record at the migration interruption when the migration interruption occurs; and use the source primary key value at the position of the migration progress record at the migration interruption as the source primary key value at the migration interruption in the source data table.

In this embodiment, the position, in the source data, of the source primary key value of the source data of each migration is determined, and the migration progress record is added to the position, so that data that has been migrated and data that has not been migrated in the source data table can be directly marked. Furthermore, when the migration interruption occurs, the position of the migration progress record at the migration interruption may be quickly and accurately determined from the source data table, and the source primary key value at the position of the migration progress record at the migration interruption is used as the source primary key value at the migration interruption, so that data migration can be continued to be performed from this position, thereby avoiding a situation in which all pieces of data need to be remigrated due to the migration interruption.

In an embodiment, the source primary key values and the source data in the source data table are stored in a form of key-value pairs; and the source primary key values are used as keys, and the source data identified by the source primary key values is used as values corresponding to the keys. The apparatus further includes:
an addition module, configured to: determine index data of each key-value pair in the source data table, the index data including the source primary key value and the source data in the key-value pair; and add the migration progress record that is generated for each source primary key value of each migration into the index data of the key-value pair to which the source data of each migration belongs.

The second determining module 1110 is further configured to: query for the index data of each key-value pair when the migration interruption occurs, to obtain index data to which the migration progress record at the migration interruption belongs; and use the source primary key value included in the obtained index data as the source primary key value at the migration interruption in the source data table.

In this embodiment, the source primary key values and the source data in the source data table are stored in the form of the key-value pairs. The source primary key values are used as the keys, and the source data identified by the source primary key values is used as the values corresponding to the keys, so that a corresponding value can be obtained based on each key. The index data corresponding to each key-value pair in the source data table is determined. The index data includes the source primary key value and the source data in the key-value pair. The migration progress record generated for the source primary key value of the source data of each migration is added into the index data corresponding to the key-value pair to which the source data of each migration belongs, so that the migration progress record can be added into the index data, to directly mark data that has been migrated. In this way, when the migration interruption occurs, the index data corresponding to each key-value pair can be queried for, and the index data to which the migration progress record at the migration interruption belongs can be quickly and accurately determined, thereby accurately determining the source primary key value at the migration interruption.

In an embodiment, the index data includes index key data. The index key data includes the source primary key value and the source data in the key-value pair. The adding module is further configured to determine index key data to which the source data of each migration belongs; and use the migration progress record that is generated for each source primary key value of each migration as index value data of the index key data to which the source data of each migration belongs.

The second determining module 1110 is further configured to: query for each piece of index value data based on each piece of index key data when the migration interruption occurs, to obtain index value data at the migration interruption; and use the source primary key value included in the index key data of the obtained index value data as the source primary key value at the migration interruption in the source data table.

In this embodiment, the index key data to which the source data of each migration belongs is determined, and the migration progress record generated based on the source primary key value of the source data of each migration is used as the index value data corresponding to the index key data to which the source data of each migration belongs, so as to directly find, based on index information, data that has been migrated in the source data table. In this way, when the migration interruption occurs, each piece of index value data may be queried for based on each piece of index key data, to quickly obtain the index value data at the migration interruption, thereby quickly determining the source primary key value at the migration interruption.

In an embodiment, the adding module is further configured to add the migration progress record that is generated for each source primary key value of each migration into the index key data to which the source data of each migration belongs.

The second determining module 1110 is further configured to: query for each piece of index key data when the migration interruption occurs, to obtain index key data to which the migration progress record at the migration interruption belongs; and determine the source primary key value included in the obtained index key data as the source primary key value at the migration interruption in the source data table.

In this embodiment, the migration progress record that is generated based on the source primary key value of the source data of each migration is added into the index key data to which the source data of each migration belongs, so that the migration progress record can be added into the index key data of the index data, to directly mark data that has been migrated. In this way, when the migration interruption occurs, the index key data at the migration interruption can be quickly determined by querying for the index key data of the index data, to quickly determine the index key data at the migration interruption, thereby accurately determining the source primary key value at the migration interruption.

In some embodiments, the apparatus further includes:
a synchronization module, configured to establish an association relationship between the source data table and the target data table; record migration initiation time of the source data table; and perform, when a data processing request for the source data table is received after the migration initiation time, an operation indicated by the data processing request on the source data table, and synchronize, based on the association relationship, the operation indicated by the data processing request to the target data table.

In this embodiment, the association relationship between the source data table and the target data table is established; the migration initiation time of the source data table is recorded; data, before the migration initiation time, in the source data table is used as the existing data, and data, generated after the migration initiation time, is used as new data. When the data processing request for the source data table is received after the migration initiation time, the processing operation of the data processing request in the source data table is synchronized to the target data table based on the association relationship, so that normal access to the source data table can be allowed during the data migration. In addition, it can be ensured that data generated during the accessing may not affect the data migration, and generated new data may be synchronized to the target data table, so that the data loss problem does not exist.

In an embodiment, the synchronization module is further configured to: determine a type of the data processing request when the data processing request for the source data table is received after the migration initiation time; determine, based on the association relationship, a trigger matching the type; and perform the operation indicated by the data processing request on the source data table, and synchronize, through the trigger matching the type, the operation indicated by the data processing request to the target data table.

In this embodiment, when the data processing request for the source data table is received after the migration initiation time, the type of the data processing request is determined; the trigger matching the type of the data processing request is determined based on the association relationship; and the processing operation of the data processing request in the source data table is synchronized to the target data table through the trigger matching the type of the data processing request, so that normal access to the source data table can be allowed during the data migration. In addition, it is ensured that data generated during the accessing may not affect the data migration, and generated new data may be synchronized to the target data table, so that the data loss problem does not exist.

The modules in the data table processing apparatus may be implemented entirely or partially through software, hardware, or a combination thereof. The above modules may be built in or independent of a processor of a computer device in a form of hardware, or may be stored in a memory of the computer device in a form of software, for the processor to invoke to execute operations corresponding to the foregoing modules.

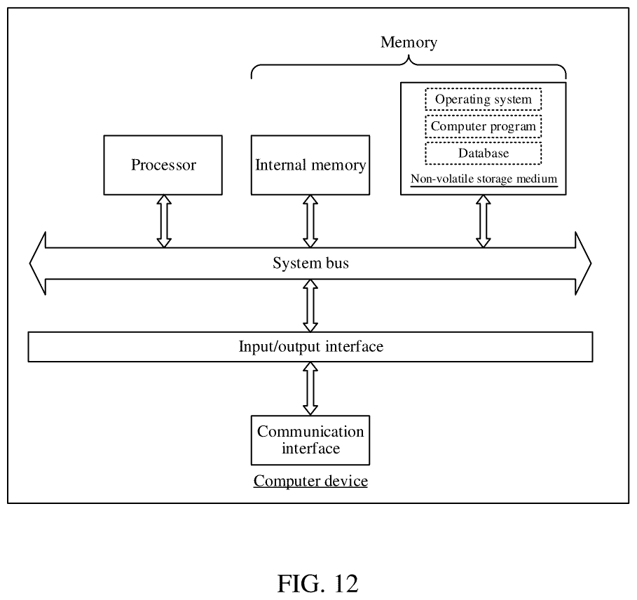

In one embodiment, a computer device is provided. The computer device may be a terminal or a server. The server is taken as an example. A diagram of an internal structure of the server may be shown in FIG. 12. The computer device includes a processor, a memory, an input/output (I/O), and a communication interface. The processor, the memory, and the input/output interfaces are connected through a system bus, and the communication interface is connected to the system bus through the input/output interface. The processor of the computer device is configured to provide computing and control capabilities. The memory of the computer device includes a non-volatile storage medium and an internal memory. The non-volatile storage medium stores an operating system, a computer program, and a database. The internal memory provides an environment for running the operating system and the computer program in the non-volatile storage medium. The database of the computer device is configured for storing data table processing data. The input/output interface of the computer device is configured for exchanging information between the processor and an external device. The communication interface of the computer device is configured for being connected to and communicating with an external terminal through a network. The computer program is run by the processor to implement a data table processing method.

A person skilled in the art can understand that the structure shown in FIG. 12 is merely a block diagram of a partial structure related to a solution in the present disclosure, and does not constitute a limitation on the computer device to which the solution in the present disclosure is applied. Specifically, the computer device may include more or fewer components than those shown in the figure, or some components may be combined, or a different component layout may be used.

In an embodiment, a computer device is further provided, including a memory and a processor. The memory has a computer program stored therein. The processor, when executing the computer program, implements the operations in the above method embodiments.

In an embodiment, a computer-readable storage medium is provided, having a computer program stored therein. The computer program, when executed by a processor, implements the operations in the above method embodiments.

In an embodiment, a computer program product is provided, including a computer program. The computer program, when executed by a processor, implements the operations in the above method embodiments.

User information (including, but not limited to, user equipment information, user personal information, and the like) and data (including, but not limited to, data for analysis, stored data, displayed data, and the like) involved in the present disclosure both are information and data that are authorized by a user or fully authorized by all parties. Acquisition, use, and processing of related data need to comply with relevant laws and regulations.

A person of ordinary skill in the art may understand that all or some of the procedures of the method in the foregoing embodiments may be implemented by the computer-readable instructions that instruct relevant hardware. The computer program may be stored in a non-volatile computer-readable storage medium. When the computer program is executed, the procedures of the foregoing method embodiments may be implemented. Any reference to a memory, a database, or other media used in the embodiments provided in the present disclosure can include at least one of a non-volatile memory and a volatile memory. The non-volatile memory may include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, and the like. The volatile memory may include a random access memory (RAM), an external cache, or the like. For the purpose of illustration rather than limitation, the RAM may be in various forms, such as a static random access memory (SRAM), or a dynamic random access memory (DRAM). The databases involved in the various embodiments provided in the present disclosure may include at least one of a relational database and a non-relational database. The non-relational database may include a blockchain-based distributed database, or the like, but is not limited thereto. The processor involved in the embodiments provided in the present disclosure may be a general-purpose processor, a central processing unit, a graphics processing unit, a digital signal processor, a programmable logic device, a quantum computing-based data processing logic device, or the like, but is not limited thereto.

All the technical features of the above embodiments can be combined randomly. For the sake of brevity, all possible combinations of all the technical features in the above embodiments are not described. However, these technical features shall all be considered to fall within the scope of this specification as long as there is no contradiction in their combinations.

In various embodiments in the present disclosure, a module may refer to a software module, a hardware module, or a combination thereof. A software module may include a computer program or part of the computer program that has a predefined function and works together with other related parts to achieve a predefined goal, such as those functions described in this disclosure. A hardware module may be implemented using processing circuitry and/or memory configured to perform the functions described in this disclosure. Each module can be implemented using one or more processors (or processors and memory). Likewise, a processor (or processors and memory) can be used to implement one or more modules. Moreover, each module can be part of an overall module that includes the functionalities of the module. The description here also applies to the term module and other equivalent terms.

In some other embodiments, a computer-readable medium comprising instructions which, when executed by a computer, cause the computer to carry out a portion or all of the above methods. The computer-readable medium may be referred as non-transitory computer-readable media (CRM) that stores data for extended periods such as a flash drive or compact disk (CD), or for short periods in the presence of power such as a memory device or random access memory (RAM). In some embodiments, computer-readable instructions may be included in a software, which is embodied in one or more tangible, non-transitory, computer-readable media. Such non-transitory computer-readable media can be media associated with user-accessible mass storage as well as certain short-duration storage that are of non-transitory nature, such as internal mass storage or ROM. The software implementing various embodiments of the present disclosure can be stored in such devices and executed by a processor (or processing circuitry). A computer-readable medium can include one or more memory devices or chips, according to particular needs. The software can cause the processor (including CPU, GPU, FPGA, and the like) to execute particular processes or particular parts of particular processes described herein, including defining data structures stored in RAM and modifying such data structures according to the processes defined by the software. In various embodiments in the present disclosure, the term “processor” may mean one processor that performs the defined functions, steps, or operations or a plurality of processors that collectively perform defined functions, steps, or operations, such that the execution of the individual defined functions may be divided amongst such plurality of processors.

The foregoing embodiments only describe several implementations of the present disclosure specifically and in detail, but cannot be construed as a limitation to the patent scope of the present disclosure. For a person of ordinary skill in the art, several transformations and improvements can be made without departing from the idea of the present disclosure. These transformations and improvements belong to the protection scope of the present disclosure. Therefore, the protection scope of the patent of the present disclosure shall be subject to the appended claims.

What is claimed is:

1. A method for data migration from a source data table to a target data table, the method comprising:
obtaining, by a device comprising a memory storing instructions and a processor in communication with the memory, source table structure information of a source data table, changing the source table structure information, and creating a target data table based on changed table structure information;
determining, by the device, a plurality of source primary keys in the source data table, each source primary key being configured for identifying a piece of source data in the source data table;
successively migrating, by the device, the source primary keys and the source data in the source data table to the target data table, by migrating at least one source primary key and the source data identified by the at least one source primary key for each migration, and each migration starting after previous migration succeeds;
generating, by the device, a migration progress record of each migration;
determining, by the device, a migration progress record at migration interruption when the migration interruption occurs, and determining a source primary key at the migration interruption in the source data table based on the migration progress record at the migration interruption; and
continuing to successively migrate, by the device starting from the source primary key at the migration interruption in the source data table, an unmigrated source primary key and unmigrated source data in the source data table to the target data table.

2. The method according to claim 1, wherein:
the source primary keys in the source data table are used as target primary keys in the target data table; and
the determining the migration progress record at migration interruption when the migration interruption occurs, and determining the source primary key at the migration interruption in the source data table based on the migration progress record at the migration interruption comprises:
determining the migration progress record at the migration interruption when the migration interruption occurs, and querying for a target primary key at the migration interruption in the target data table,
updating the migration progress record at the migration interruption based on the target primary key, and
determining the source primary key at the migration interruption in the source data table based on the updated migration progress record.

3. The method according to claim 2, wherein:
the migration progress record is stored in a progress data table; and
the determining the source primary key at the migration interruption in the source data table based on the updated migration progress record comprises:
determining a composite primary key in the progress data table, the composite primary key being a combination of a table name of the source data table and a database name of a database, and the database being configured for storing the source data table, and
determining the source primary key at the migration interruption in the source data table based on the composite primary key and the updated migration progress record.

4. The method according to claim 3, further comprising:
obtaining the table name of the source data table, and determining the database name of the database that stores the source data table;
constructing the progress data table, the progress data table comprising a table field name, a database field name, and a record field name, the migration progress record being used as record field content of the record field name;
using the table name of the source data table as table field content in the table field name, and using the database name of the database as database field content in the database field name; and
configuring the table field content and the database field content as the composite primary key of the progress data table.

5. The method according to claim 1, wherein the successively migrating the source primary keys and the source data in the source data table to the target data table comprises:
determining respective migration orders of the plurality of source primary keys based on positions of the plurality of source primary keys in the source data table; and
successively migrating the source primary keys and the source data in the source data table to the target data table based on the migration orders of the plurality of source primary keys.

6. The method according to claim 1, wherein:
the method further comprises:
determining a corresponding position of at least one source primary key of each migration in the source data table, and adding the migration progress record of each migration to the corresponding position; and
the determining the migration progress record at migration interruption when the migration interruption occurs, and determining the source primary key at the migration interruption in the source data table based on the migration progress record at the migration interruption comprises:
determining, from the source data table, a position of the migration progress record at the migration interruption when the migration interruption occurs, and
using the source primary key at the position of the migration progress record at the migration interruption as the source primary key at the migration interruption in the source data table.

7. The method according to claim 1, wherein:
the source primary keys and the source data in the source data table are stored in a form of key-value pairs; the source primary keys are used as keys, and the source data identified by the source primary keys is used as values corresponding to the keys; and
the method further comprises:
determining index data of each key-value pair in the source data table, the index data comprising the source primary key and the source data in the key-value pair, and
adding the migration progress record that is generated for at least one source primary key of each migration into the index data of the key-value pair to which the source data of each migration belongs; and
the determining the migration progress record at migration interruption when the migration interruption occurs, and determining the source primary key at the migration interruption in the source data table based on the migration progress record at the migration interruption comprises:
querying for the index data of each key-value pair when the migration interruption occurs, to obtain index data to which the migration progress record at the migration interruption belongs, and
using the source primary key comprised in the obtained index data as the source primary key at the migration interruption in the source data table.

8. The method according to claim 7, wherein:
the index data comprises index key data;
the index key data comprises the source primary key and the source data in the key-value pair;
the adding the migration progress record that is generated for at least one source primary key of each migration into the index data of the key-value pair to which the source data of each migration belongs comprises:
determining index key data to which the source data of each migration belongs, and
using the migration progress record that is generated for at least one source primary key of each migration as index value data of the index key data to which the source data of each migration belongs;
the querying for the index data of each key-value pair when the migration interruption occurs, to obtain index data to which the migration progress record at the migration interruption belongs comprises:
querying for each piece of index value data based on each piece of index key data when the migration interruption occurs, to obtain index value data at the migration interruption; and
the using the source primary key comprised in the obtained index data as the source primary key at the migration interruption in the source data table comprises:
using the source primary key comprised in the index key data of the obtained index value data as the source primary key at the migration interruption in the source data table.

9. The method according to claim 8, further comprising:
adding the migration progress record that is generated for each source primary key of each migration into the index key data to which the source data of each migration belongs;
querying for each piece of index key data when the migration interruption occurs, to obtain index key data to which the migration progress record at the migration interruption belongs; and
determining the source primary key comprised in the obtained index key data as the source primary key at the migration interruption in the source data table.

10. The method according to claim 1, further comprising:
establishing an association relationship between the source data table and the target data table;
recording migration initiation time of the source data table; and
performing, when a data processing request for the source data table is received after the migration initiation time, an operation indicated by the data processing request on the source data table, and synchronizing, based on the association relationship, the operation indicated by the data processing request to the target data table.

11. The method according to claim 10, wherein the performing, when the data processing request for the source data table is received after the migration initiation time, the operation indicated by the data processing request on the source data table, and synchronizing, based on the association relationship, the operation indicated by the data processing request to the target data table comprises:
determining a type of the data processing request when the data processing request for the source data table is received after the migration initiation time;
determining, based on the association relationship, a trigger matching the type; and
performing the operation indicated by the data processing request on the source data table, and synchronizing, through the trigger matching the type, the operation indicated by the data processing request to the target data table.

12. An apparatus for data migration from a source data table to a target data table, the apparatus comprising:
a memory storing instructions; and
a processor in communication with the memory, wherein, when the processor executes the instructions, the processor is configured to cause the apparatus to perform:
obtaining source table structure information of a source data table, changing the source table structure information, and creating a target data table based on changed table structure information,
determining a plurality of source primary keys in the source data table, each source primary key being configured for identifying a piece of source data in the source data table,
successively migrating the source primary keys and the source data in the source data table to the target data table, by migrating at least one source primary key and the source data identified by the at least one source primary key for each migration, and each migration starting after previous migration succeeds,
generating a migration progress record of each migration,
determining a migration progress record at migration interruption when the migration interruption occurs, and determining a source primary key at the migration interruption in the source data table based on the migration progress record at the migration interruption, and
continuing to successively migrate, starting from the source primary key at the migration interruption in the source data table, an unmigrated source primary key and unmigrated source data in the source data table to the target data table.

13. The apparatus according to claim 12, wherein:
the source primary keys in the source data table are used as target primary keys in the target data table; and
when the processor is configured to cause the apparatus to perform determining the migration progress record at migration interruption when the migration interruption occurs, and determining the source primary key at the migration interruption in the source data table based on the migration progress record at the migration interruption, the processor is configured to cause the apparatus to perform:
determining the migration progress record at the migration interruption when the migration interruption occurs, and querying for a target primary key at the migration interruption in the target data table,
updating the migration progress record at the migration interruption based on the target primary key, and
determining the source primary key at the migration interruption in the source data table based on the updated migration progress record.

14. The apparatus according to claim 13, wherein:
the migration progress record is stored in a progress data table; and
when the processor is configured to cause the apparatus to perform determining the source primary key at the migration interruption in the source data table based on the updated migration progress record, the processor is configured to cause the apparatus to perform:
determining a composite primary key in the progress data table, the composite primary key being a combination of a table name of the source data table and a database name of a database, and the database being configured for storing the source data table, and
determining the source primary key at the migration interruption in the source data table based on the composite primary key and the updated migration progress record.

15. The apparatus according to claim 14, wherein, when the processor executes the instructions, the processor is configured to further cause the apparatus to perform:
obtaining the table name of the source data table, and determining the database name of the database that stores the source data table;
constructing the progress data table, the progress data table comprising a table field name, a database field name, and a record field name, the migration progress record being used as record field content of the record field name;
using the table name of the source data table as table field content in the table field name, and using the database name of the database as database field content in the database field name; and
configuring the table field content and the database field content as the composite primary key of the progress data table.

16. The apparatus according to claim 12, wherein, when the processor is configured to cause the apparatus to perform successively migrating the source primary keys and the source data in the source data table to the target data table, the processor is configured to cause the apparatus to perform:
determining respective migration orders of the plurality of source primary keys based on positions of the plurality of source primary keys in the source data table; and
successively migrating the source primary keys and the source data in the source data table to the target data table based on the migration orders of the plurality of source primary keys.

17. The apparatus according to claim 12, wherein:
when the processor executes the instructions, the processor is configured to further cause the apparatus to perform:
determining a corresponding position of at least one source primary key of each migration in the source data table, and adding the migration progress record of each migration to the corresponding position; and
when the processor is configured to cause the apparatus to perform determining the migration progress record at migration interruption when the migration interruption occurs, and determining the source primary key at the migration interruption in the source data table based on the migration progress record at the migration interruption, the processor is configured to cause the apparatus to perform:
determining, from the source data table, a position of the migration progress record at the migration interruption when the migration interruption occurs, and
using the source primary key at the position of the migration progress record at the migration interruption as the source primary key at the migration interruption in the source data table.

18. The apparatus according to claim 12, wherein:
the source primary keys and the source data in the source data table are stored in a form of key-value pairs; the source primary keys are used as keys, and the source data identified by the source primary keys is used as values corresponding to the keys; and
when the processor executes the instructions, the processor is configured to further cause the apparatus to perform:
determining index data of each key-value pair in the source data table, the index data comprising the source primary key and the source data in the key-value pair, and
adding the migration progress record that is generated for at least one source primary key of each migration into the index data of the key-value pair to which the source data of each migration belongs; and
when the processor is configured to cause the apparatus to perform determining the migration progress record at migration interruption when the migration interruption occurs, and determining the source primary key at the migration interruption in the source data table based on the migration progress record at the migration interruption, the processor is configured to cause the apparatus to perform:
querying for the index data of each key-value pair when the migration interruption occurs, to obtain index data to which the migration progress record at the migration interruption belongs, and
using the source primary key comprised in the obtained index data as the source primary key at the migration interruption in the source data table.

19. The apparatus according to claim 12, wherein, when the processor executes the instructions, the processor is configured to further cause the apparatus to perform:
establishing an association relationship between the source data table and the target data table;
recording migration initiation time of the source data table; and
performing, when a data processing request for the source data table is received after the migration initiation time, an operation indicated by the data processing request on the source data table, and synchronizing, based on the association relationship, the operation indicated by the data processing request to the target data table.

20. A non-transitory computer-readable storage medium, storing computer-readable instructions, wherein, the computer-readable instructions, when executed by a processor, are configured to cause the processor to perform:
obtaining source table structure information of a source data table, changing the source table structure information, and creating a target data table based on changed table structure information,
determining a plurality of source primary keys in the source data table, each source primary key being configured for identifying a piece of source data in the source data table,
successively migrating the source primary keys and the source data in the source data table to the target data table, by migrating at least one source primary key and the source data identified by the at least one source primary key for each migration, and each migration starting after previous migration succeeds,
generating a migration progress record of each migration,
determining a migration progress record at migration interruption when the migration interruption occurs, and determining a source primary key at the migration interruption in the source data table based on the migration progress record at the migration interruption, and
continuing to successively migrate, starting from the source primary key at the migration interruption in the source data table, an unmigrated source primary key and unmigrated source data in the source data table to the target data table.
